(19) United States
(12) Patent Application Publication
(10) Pub. No.: US 2001/0048420 A1
(43) Pub. Date: Dec. 6, 2001

(54) Display apparatus including optical modulation element

(76) Inventors: Tsunenori Yamamoto, Hitachi (JP); Ikuo Hiyama, Hitachi (JP); Shinichi Komura, Hitachi (JP); Tetsuya Aoyama, Hitachi (JP); Hajime Akimoto, Oume (JP); Katsuyuki Funahata, Hitachi (JP); Kazuhiro Kuwabara, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/817,217

(22) Filed: Mar. 27, 2001

(30) Foreign Application Priority Data
May 30, 2000 (JP) 2000-160825

(51) Int. Cl. G09G 3/36

(52) U.S. Cl. 345/89; 345/87

(57) ABSTRACT

A display apparatus is capable of adapting to sufficiently increase display frequency even with an optical modulation element which has fairly low response speed and can rewrite image at high speed. The display apparatus of a system separately performs mapping of display data for optical modulation element of each pixel and application of gradation information. The display apparatus divides a display period of one frame into a plurality of sub-frames, controls input value for the optical modulation element independently per each sub-frame in the plurality of sub-frames, and displays image with gradation display by the optical modulation element.

### BACKGROUND OF THE INVENTION

The present invention relates to a display apparatus including an optical modulation element. More particularly, the invention relates to a display apparatus of a luminance gradation modulation system.

In the recent years, reduction of thickness and weight of an image display apparatus has been progressed. In place of CRT which has been primary image display device, a flat panel display, such as a liquid crystal display, PDP (Plasma Display Panel), ELD (Electroluminescent Display) has been rapidly spreading.

On the other hand, concerning performance of a display apparatus, associating with spreading of personal computer (PC), digital video disk (DVD), digital television broadcasting, display with high definition and high or multiple level gradation has been becoming essential.

Demand for higher performance, particularly higher definition level of the image display apparatus is expected to be grown toward the future. Degradation of image quality when a dynamic image is displayed in a hold illumination type image display apparatus, such as liquid crystal display, has been reported in the Institute of Telecommunications Engineers Technical Report EID 96-4, pp. 19-26 (June, 1996).

According to this report, due to unmatching of a dynamic image in hold illumination and a radial motion of human eye upon following dynamic image, bluing of dynamic image can be caused to lower image quality of the dynamic image display.

In the above-identified, it has been reported that a method for multiplying a frame frequency for n times and other method may improve for lowering of image quality of the dynamic image display. In short, in order to attain clear dynamic image in the hold illumination type display apparatus, such as a liquid crystal display, display frequency has to be made higher.

However, as set forth above, in the current display method of the image or the driving system of the image display apparatus, increasing of the display frequency is becoming closer to limit. Accordingly, for this fact, the foregoing method is difficult to realize.

The conventional display method for displaying an image with rewriting at high speed corresponding to increasing of display frequency has been disclosed in Japanese Patent Application Laid-Open No. 11-75144 (1999), for example.

In the disclosed display method, two memories and two kinds of means for driving pixel according to contents of the memories are provided per each pixel including an optical modulation element. For all pixels forming a preliminarily displayed image, data is written in the first memory in each pixel. Subsequently, the contents of the first memories are transferred to the second memories all together simultaneously for controlling ON and OFF of light at each pixel according to data in the second memories at high speed for PWM (pulse width modulation) control for multiple level gradation image display.

The above-mentioned prior art encounters a problem in multiple-level gradation display performance since no consideration has been given for necessity of high speed optical modulation element for each pixel.

Namely, since the conventional display method obtains multiple level gradation display by PWM control, high response speed is required for the optical modulation element used in each pixel.

On the other hand, in the prior art, ferroelectric liquid crystal or antiferroelectric liquid crystal and so forth is used for the optical modulation element. Such liquid crystal requires difficult fabrication process, such as orientation control or gap adjustment. Also, since electrostatic capacity is relatively large, drive control is difficult.

Furthermore, in the PWM control, it is not possible to drive the display in saturated luminance output (=all white display) condition over an entire period of one frame. Therefore, there is a limitation in light using efficiency and illumination period efficiency to cause difficulty in attaining gradation display at maximum value.

### SUMMARY OF THE INVENTION

It is an object of the present invention to provide a display apparatus which can adapt to sufficiently increase display frequency even with an optical modulation element which has fairly low response speed and can rewrite image at high speed.

By permitting use of optical modulation element having low response speed, kinds of the available optical modulation elements can be increased, such as TN type or IPS type liquid crystal, and elements which are easy to control mass production process or drive control may be used.

On the other hand, another object of the present invention is to provide a bright and high performance display apparatus which can satisfactorily improve light use efficient or illumination period efficiency.

According to one aspect of the invention, a display apparatus of a system for separately performing mapping of display data for optical modulation element of each pixel and application of gradation information, comprises: a display period of one frame being divided into a plurality of sub-frames; input value for the optical modulation element being controlled independently per each sub-frame in the plurality of sub-frames; and image being displayed with gradation display by the optical modulation element.

The optical modulation element may be constructed with a liquid crystal having response speed longer than or equal to 5 msec.

The mapping of the display data for the optical modulation element may be performed with a construction of a substantially orthogonal two signal wiring and a first active element arranged at the intersection of the two signal wiring for performing mapping of the display data in a first memory of each pixel, and application of gradation information for the optical modulation element may be performed by transferring the display data mapped in the first memory to a second memory in each pixel by a second active element in each pixel, and an input value is transferred to the optical modulation element by a third active element in each pixel. In the alternative, the mapping of the display data for the optical modulation element is performed by mapping of the display data in a first memory in each pixel using a shift register incorporated per one stage in the pixel, and application of gradation information for the optical modulation element may be applied by transferring the an input value to the optical modulation element according to the display data transferred to the first memory.

First gradation information may be applied simultaneously with mapping of the image data for the pixel,

Second gradation information is applied for the pixels independently of mapping, and luminance gradation modulation may be performed per sub-frame simultaneously using the first gradation information and the second gradation information for obtaining gradation display.

When an image having number of gradation levels of substantially 2ⁿ is to be displayed, one frame period as a period for displaying one frame of screen image may be divided into n in number of equal period sub-frames, in each sub-frame, each pixel may be selected into display condition and non-display condition according to a preliminarily mapped display data, and an input value for luminance gradation of the pixel to display in each sub-frame may be mutually differentiated.

The input value for the luminance gradation of the pixel to be displayed in each sub-frame may be any one of 1B, 2B, 2²B, . . . 2ⁿB with taking the input value for the lowest luminance gradation is 1B. Total value or effective value of all sub-frame of the input values for luminance gradation of the pixel to be displayed in each sub-frame may be substantially equal to the input value required for saturated luminance output of the optical modulation element. The pixel in certain frame or certain sub-frame may be displayed using information of pixel in preceding frame or preceding sub-frame in time.

When an image having number of gradation levels of substantially 2ⁿ is to be displayed, one frame period as a period for displaying one frame of screen image may be divided into less than or equal to n in number of equal period sub-frames, each pixel in each sub-frame may be selectively held at the input value for luminance gradation of preceding frame according to the preliminarily mapped display data or newly applied the input value, the input values for luminance gradation to be newly applied in each sub-frame are mutually differentiated. The input value for the luminance gradation to be newly applied in each sub-frame may be adjusted according to detection of gradation information of the image to be displayed. An image having number of gradation levels of substantially 2ⁿ maybe to be displayed, one frame period as a period for displaying one frame of screen image may be divided into less than n in number of equal period sub-frames. Number of gradation levels of display image may be detected and number of sub-frames in one frame period is adjusted depending upon result of detection of number of gradation levels. Number of sub-frames in one frame period may be adjusted by varying number of gradation levels of the display image for adjusting a driving frequency. Number of sub-frames in one frame period may be adjusted by varying number of gradation levels of the display image for adjusting one frame period. Number of gradation levels of the image to be displayed over a several frame period may be adjusted by adjusting input value for luminance gradation to be newly applied in each sub-frame, per frame.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is an explanatory illustration of a driving condition in the first embodiment of a display apparatus according to the present invention;

FIG. 2 is a circuit diagram of a pixel in the first embodiment of the invention;

FIG. 3 is an illustration showing an overall construction of the first embodiment of the display apparatus according to the invention;

FIG. 4 is an explanatory illustration showing one example of data conversion in a display controller in the first embodiment of the present invention;

FIG. 5 is an explanatory illustration showing a driving condition in the second embodiment of the present invention;

FIG. 6 is an explanatory illustration showing a driving condition in the third embodiment of the present invention;

FIG. 7 is a circuit diagram of a pixel in the fourth embodiment of the present invention;

FIG. 8 is a circuit diagram of a pixel in the fifth embodiment of the present invention;

FIG. 9 is an explanatory illustration showing a driving condition in the fifth embodiment of the present invention;

FIG. 10 is a circuit diagram of a pixel in the sixth embodiment of the present invention;

FIG. 11 is an explanatory illustration showing a driving condition in the sixth embodiment of the present invention;

FIG. 12 is an illustration showing an overall construction of the seventh embodiment of the display apparatus according to the present invention;

FIG. 13 is a block diagram of an expansion display controller in the seventh embodiment of the present invention;

FIG. 14 is an explanatory illustration showing a driving condition in the eighth embodiment of the present invention;

FIG. 15 is a block diagram of an expansion display controller in the ninth embodiment of the present invention;

FIG. 16 is an explanatory illustration showing a driving condition in the tenth embodiment of the present invention;

### DESCRIPTION OF THE PREFERRED EMBODIMENTS

The present invention will be discussed hereinafter in detail in terms of the preferred embodiments of a display apparatus according to the present invention with reference to the accompanying drawings. In the following description, numerous specific details are set forth in order to provide a thorough understanding of the present invention. It will be obvious, however, to those skilled in the art that the present invention may be practiced without these specific detailed. In the other instance, well known structure are not shown in detail in order to avoid unnecessary obscurity of the present invention.

### First Embodiment

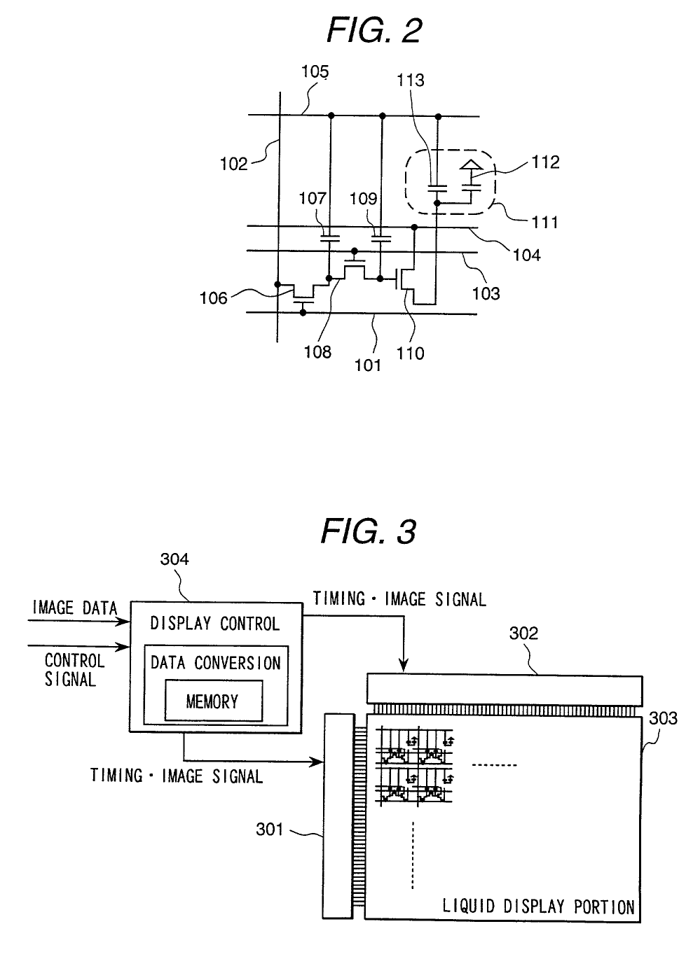

At first, the first embodiment of a display apparatus according to the present invention will be discussed with reference to a circuit diagram of FIG. 2.

As shown FIG. 2, the first embodiment of the display apparatus is constructed with arranging scanning wiring 101, control signal line 103, an applied voltage wiring 104 and a common wiring in row direction and arranging data signal wiring 102 in column direction. Respective pixels are arranged on intersection of respective of matrix form.

Here, each pixel is constructed with a first active element 106, a first pixel memory 107, a second active element 108, a second pixel memory 109, a third active element 110 and an optical modulation element 111. Also, the optical modulation element 111 is constructed with a liquid crystal 112 and a holding capacitor 113.

A gate terminal of the first active element 106 is connected to the scanning wiring 101. by this, the first active element 106 is turned on when a selection voltage is applied. At this time, a potential of the data signal wiring 102 is written in the first pixel memory 107.

Subsequently, when the selection voltage is applied to the control signal wiring 103, the second active element 108 disposed between the first pixel memory 107 and the second pixel memory 109 becomes conductive. Thus, the potential of the first pixel memory 107 is transferred to the second pixel memory 109.

Since the second pixel memory 109 is connected to the gate terminal of the third active element 110, the thirds active element 110 is controlled by the potential transferred to the second pixel memory 109 for applying a voltage of the applied voltage wiring 104 to the optical modulation element 111.

The foregoing is substantially equivalent operation as the display apparatus of the system separately performing mapping of the display data for the conventional optical modulation element and providing of information. However, inn the shown embodiment, TN (twisted nematic) type liquid crystal 112 is used as the optical modulation element 111. The third active element 110 is designed for writing the voltage of the applied voltage wiring 104 to the liquid crystal 112 and the holding capacitor 113.

The liquid crystal 112 varies orienting condition of liquid crystal axis in a cell depending upon the written voltage to control polarizing direction of the light to modulate pixel luminance.

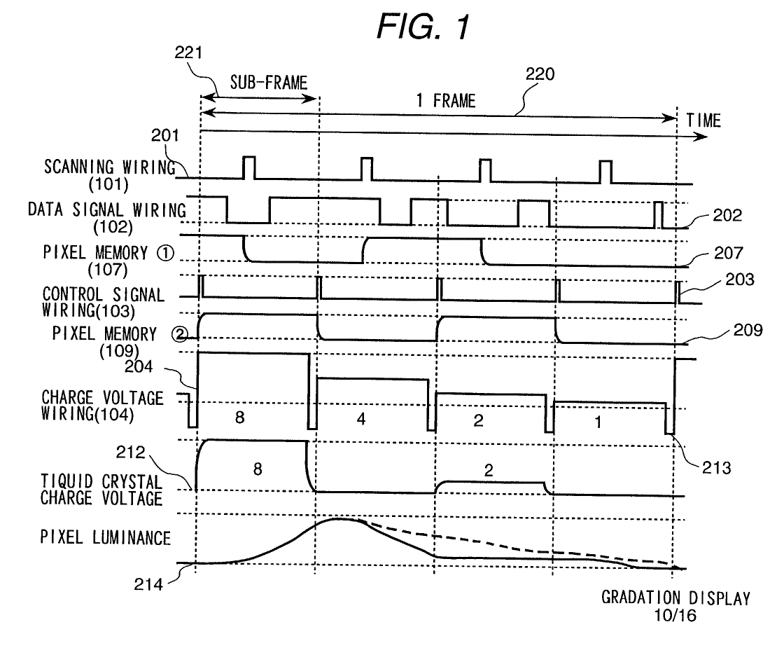

Next, driving and display operation of the first embodiment of the display apparatus will be discussed with reference to FIG. 1.

At first, in the first embodiment, one frame period 220, namely display period of one screen image, is divided into sub-frames 221 of number corresponding to number n of gradation bits in pixel of each color of R (red), G (green) and B (blue), which pixel of each color in one pixel will be hereinafter referred to as “sub-pixel” or “pixel component”. Here, gradation level of the pixel component is controlled by four bits. Therefore, number of gradation bit becomes four. Thus, one frame is divided into four sub-frames.

The scanning wiring 110 is sequentially selected from one side of the display screen in each sub-frame 221 to complete scan within one sub-frame period. Namely, as a voltage 201 to be applied to one scanning wiring 101, the voltage is selected to be applied only once in one sub-frame period. It should be noted that, in FIG. 1, only first sub-frame 221 is illustrated.

By the selection voltage to be applied to the scanning wiring, the first active element 106 becomes conductive. Here, the voltage 207 of the first pixel memory 107 is equal to the voltage 202 to be applied to the data signal wiring 102. As a result, in the first pixel memories 107 of all pixels of the display screen, the display data is mapped.

At this time, the display data for mapping is merely signal having two values of selected and not selected. Therefore, even in consideration of wiring delay, mapping can be performed in quite short period. Therefore, even within the sub-frame divided into n, satisfactory data mapping can be performed easily. It should be noted that one frame period in high speed display is about 1/60 seconds (=about 16.6 msec.) similarly to NTSC system, for example.

As set forth above, after mapping the display data, the data transfer voltage 203 is applied to the control signal wiring 103. By this, the voltage 207 of the first pixel memory 107 is transferred to a potential 209 of the second pixel memory 109 to be maintained within the next sub-frame period.

Then, by the potential 209 of the second pixel memory 109, the conducting state of the third active element 110 is controlled. Then, the analog gradation value to be applied to the applied voltage wiring 104 is determined to be applied to the liquid crystal 112 or not.

Here, in case of the shown embodiment, the writing period of the analog gradation value for the optical modulation element 11 is comparable with the sub-frame period. Therefore, writing period can be certainly obtained for facilitating writing.

On the other hand, in the shown embodiment, since writing of analog gradation value for the optical modulation element 111 and mapping of the display data are separated, no blank period is present at the interval between the sub-frames. Furthermore, high speed rewriting of image becomes possible.

Here, in case of FIG. 1, since the voltage 209 of the second pixel memory 109 is in selected condition in the first sub-frame and the third sub-frame, the voltage 204 of the applied voltage wiring 104 is serving as the liquid crystal applied voltage 212.

Here, as shown, during the sub-frame period, the final timing, the liquid crystal applied voltage clear pulse 213 is applied to the applied voltage wiring 104. Then, the liquid crystal applied voltage clear pulse is also applied to the common wiring 105, while not illustrated.

Accordingly, the third active element 110 becomes conductive state by the clear pulse 213. As a result, the liquid crystal applied voltage 212 is cleared at the end timing of each sub-frame. Therefore, in the sub-frame where the second pixel memory 109 is in non-selected state, the voltage is not applied to the liquid crystal 112. The value of the liquid crystal applied voltage 212 is independent per sub-frame, and can take different value.

Then, when the value of the liquid crystal applied voltage 212 is applied to the liquid crystal, with reference to a voltage E for the lowest luminance value, namely luminance value at the lowest gradation level, in one frame to be luminance modulated, the voltage levels for respective gradation levels are set to be 2ⁿE (E is multiplied by 2 to the (n)th power, wherein n is integer), namely, the voltage value 2E (2=2¹), the voltage value 4E (4=2²), the voltage value 8E (8=2³), . . . 2⁻¹E (n is number of sub-frames which equals to gradation bit number). This is one of feature of the first embodiment.

Here, FIG. 1 shows the case where n=4, namely number of gradation levels is 16 (=2⁴). Accordingly, in the fourth sub-frame period, the voltage E for the lowest luminance value in one frame is applied to the applied voltage wiring 104, in the third sub-frame, the voltage 2E is applied, and in the second and first sub-frames, the voltages 4E and 8E are applied, respectively.

Then, assuming that the luminance is proportional to the applied voltage, and assuming that the luminance value when the voltage value E is L, the luminance at the voltage value 2E becomes 2L. Similarly, at the voltage 4E,the luminance value becomes 4L, at the voltage 8E, the luminance value becomes 8L, and at the voltage value 2⁽ⁿ⁻¹⁾E, the luminance value becomes 2⁽ⁿ⁻¹⁾L.

It should be appreciated that the liquid crystal is an element controlling a light transmission amount. Strictly, the liquid crystal does not control luminance. However, in viewpoint of pixel display, it should be the same. Therefore, the discussion will be given as luminance being controlled.

In case of FIG. 1, the voltage 209 of the second pixel memory 109 becomes high level in the first sub-frame period and the third sub-frame period. Accordingly, in the first sub-frame period, the liquid crystal 112 becomes the luminance level 8L, and in the third sub-frame period, the liquid crystal 112 becomes luminance level 2L. As a result, during this frame period, the gradation display by the optical modulation element 111 becomes 10/16.

In the first embodiment, TN type liquid crystal is employed as the liquid crystal 112. At this time, among TN system, one having relatively short response period, e.g. 5 msec. is selected. Therefore, as shown in FIG. 1, when the voltage is applied to the liquid crystal 112 during the first sub-frame period and the third sub-frame period, the pixel luminance 214 has a luminance display characteristics, in which a peak is reached after the first sub-frame as shown by solid line, and subsequently lowered slowly.

Here, FIG. 1 shows the case where the voltage is applied to the first sub-frame and the third sub-frame, at this time, the gradation display is 10/16. However, when the voltage is applied to the liquid crystal at all of sub-frames, display characteristics becomes as shown by broken line to be the maximum luminance.

Accordingly, in case of the shown embodiment, by combination of the sub-frames to apply the voltage, sixteen kinds of gradation display can be obtained.

Namely, in the shown embodiment, one frame period 220 is divided into a plurality of sub-frames. Then, by applying independent voltage is applied to the optical modulation element 111 during each of sub-frame, gradation display can be obtained. Hereinafter, multiple level gradation display method as set forth above will be referred to as sub-frame luminance gradation modulation method.

Accordingly, by the shown embodiment, since the liquid crystal 112 forming the optical modulation element 111 is not subject to high frequency switching control, different from the prior art employing PWM, even for the display apparatus having high display frequency and large number of gradation levels, the liquid crystal material requiring difficult manufacturing process or driving method, such as ferroelectric liquid crystal or antiferroelectric liquid crystal is not necessary to be used. Therefore, TN type or IPS (In Plane Switching) type liquid crystal which are typically used in the existing liquid crystal display apparatus may be used as they are.

FIG. 3 is an illustration showing an overall construction of the first embodiment of the display apparatus according to the invention.

A liquid crystal display portion 303 is formed by arranging pixels shown in FIG. 2 in matrix fashion. In the left side portion of the liquid crystal display portion 303, a side portion wiring driving circuit 301 is arranged, and on upper portion, an upper side wiring driving circuit 302 is arranged.

As shown in FIG. 2, since the scanning wiring 101, the control signal wiring 103, the liquid crystal applied voltage wiring 104 and the common wiring 105 are arranged laterally (row direction), they are driven by the side portion wiring driving circuit 301, and the data signal wiring 102 is arranged in vertical direction (column direction), it is driven by the upper portion wiring driving circuit 302.

It should be noted that wiring other than the scanning wiring 101 and the data signal wiring 102 might be arranged in vertical direction instead of lateral direction. Furthermore, the side portion wiring driving circuit 301 is not necessarily located at the left side but can be right side. Also, the upper portion wiring driving circuit 302 is not necessarily located at the upper side but can be lower side.

Here, in the shown embodiment, a display controller 304 is provided receiving the image data for converting into the image data necessary for the driving method according to the present invention and transferring the timing signal and the image data signal to the wiring driving circuit, in the display apparatus.

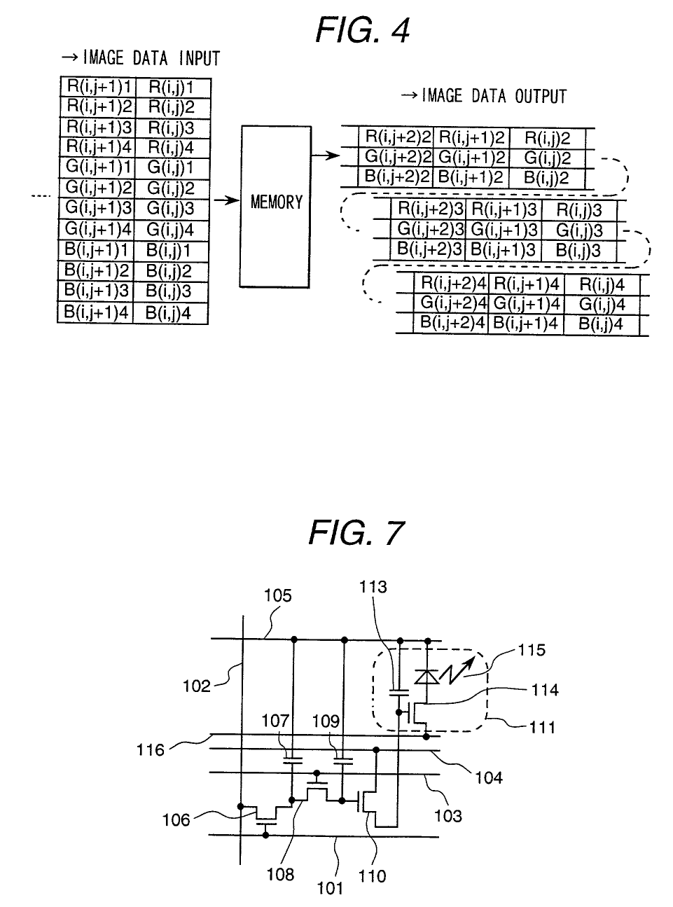

At this time, the image data is typically input as parallel chrominance data and gradation data of pixel (i, j) forming the screen image as shown in a form of image data input in FIG. 4.

Therefore, in the display controller, the input image data is once stored in the memory, converted and output to the image data of all pixels per gradation data bit, as shown in FIG. 4.

It should be noted that, in the shown embodiment, after receiving normal image data, the image data is converted in the display controller 304. However, when the imaged data source can supply the image data shown as image data output in FIG. 4, a data converting portion of the display controller 304 becomes unnecessary.

As set forth above, in the first embodiment, the frame is divided into a plurality of sub-frames, the luminance control voltage to be applied to the optical modulation element is controlled into independent voltage value in each of plurality of sub-frame to obtain gradation display by sub-frame luminance gradation modulation method. Therefore, even when the TN type or IPS type liquid crystal which have relatively low response speed, is employed, the display apparatus capable of high speed display can be obtained easily.

As a result, with the shown embodiment, since kinds of useful optical modulation element is increased to increase margin of designing, facilitate manufacturing. Furthermore, when the TN type liquid crystal is used as in the shown embodiment, mass production process and driving control are facilitated to gain superior position in viewpoint of cost.

### Second Embodiment

Next, the second embodiment of the present invention will be discussed.

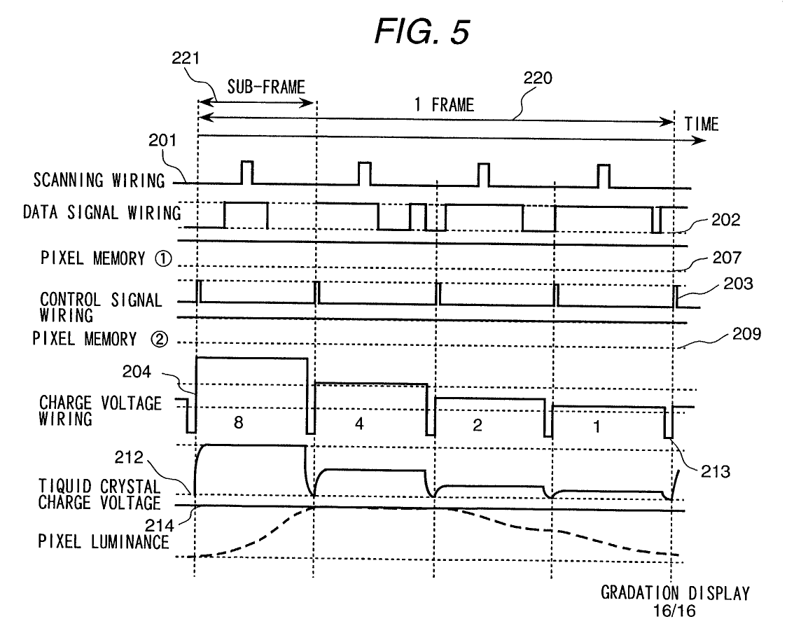

At first, the second embodiment is similar to the first embodiment except for driving operation shown in FIG. 5. Also, driving methods of the scanning wiring 101, the data signal wiring 102, the control signal wiring 103, the active elements 106, 108 and the pixel memories 107, 109 are the same as those of the first embodiment.

On the other hand, the voltage 204 applied to the applied voltage wiring 104 is set to be 2ⁿE (E is multiplied by 2 to the (n)th power, wherein n is integer), namely, the voltage value 2E (2=2¹), the voltage value 4E (4=2²), the voltage value 8E (8=2³), . . . 2ⁿ⁻¹E (n is number of sub-frames which equals to gradation bit number) for establishing luminance levels of one time, two times (double), square of 2, . . . 2 to the (n−1)th power of the reference or minimum luminance level, per sub-frame. However, in the second embodiment, the effective values of the voltage value to be applied in each sub-frame in all of sub-frame period (=one frame period) are set to be equal to the voltage value for attaining saturated luminance output of the liquid crystal 112. This is another different point to the first embodiment.

Then, in the second embodiment, as the optical modulation element 111, the liquid crystal 112 of TN type material having about 20 nsec is used. Therefore, the luminance value in each pixel is responsive to the effective value of the voltage within one frame period (=about 16.6 msec.). As a result, as shown in FIG. 5, when gradation display corresponding to all while is output, as shown by pixel luminance 214 in solid line, saturation luminance output can be obtained throughout one frame period.

It should be noted that the liquid crystal having response period of about 5 msec. as employed in the first embodiment, could be employed.

In this case, the gradation characteristics may be characteristics in the pixel luminance 214 of FIG. 5 in broken line. Even with this, high pixel luminance output comparable with that of the first embodiment can be obtained.

Accordingly, even in the second embodiment, as multiple gradation display method, the sub-frame luminance gradation modulation is used to make the effective input value (effective voltage value) in one frame period equal to the input value (voltage value) corresponding to the saturation luminance display. This enables use of the optical modulation element, such as TN type or IPS type liquid crystal having relatively low response speed. Furthermore, saturated luminance output or luminance output can be obtained throughout one frame period to significantly improve illumination efficiency to easily obtain bright display.

### Third Embodiment

Next, the third embodiment of the present invention will be discussed.

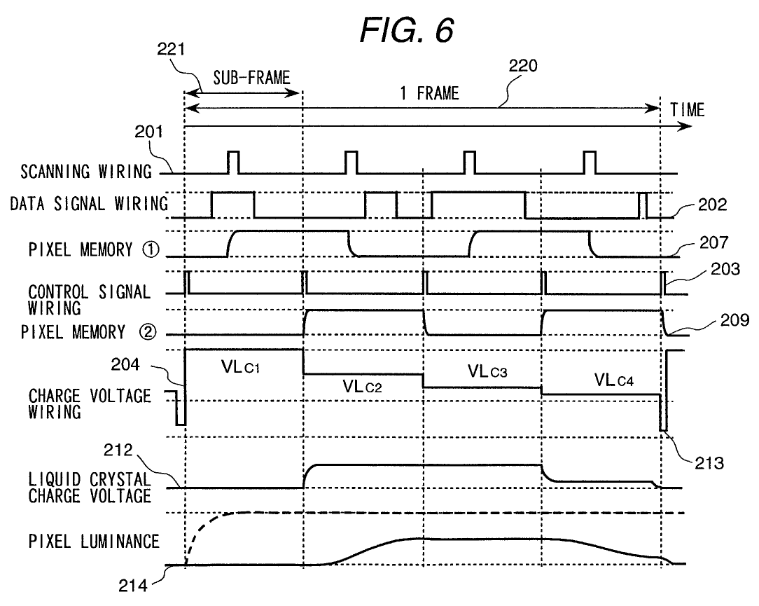

At first, the third embodiment is similar to the first embodiment except for driving operation shown in FIG. 6. Also, driving methods of the scanning wiring 101, the data signal wiring 102, the control signal wiring 103, the active elements 106, 108 and the pixel memories 107, 109 are the same as those of the first embodiment.

However, in the third embodiment, the liquid crystal applied voltage clear pulse 213 applied at the end of each sub-frame in the first embodiment, is applied only once at the end of one frame period different from the first embodiment. Also, the voltage applied to the applied voltage wiring 104 per sub-frame is not the voltage values for establishing luminance levels of one time, two times (double), square of 2, . . . 2 to the (n−1)th power of the reference or minimum luminance level, per sub-frame as in the former embodiment.

As a result, at first, in the third embodiment, the liquid crystal applied voltage clear pulse 213 is applied per sub-frame. Therefore, the voltage to be applied to the liquid crystal 112 in the pixel not to be written the voltage from the applied voltage wiring 104 in each sub-frame is maintained at the voltage applied to the corresponding sub-frame in the preceding frame period.

In this case, the display data mapped in the first pixel memory 107 by the scanning wiring 101 and the data signal wiring 102 becomes data for selecting between holding at the voltage of the current sub-frame as the liquid crystal applied voltage 212 in the next sub-frame or writing the voltage to be newly applied to the applied voltage wiring 104.

Thus, in each sub-frame, luminance gradation modulation is realized by operation for selecting maintaining of the liquid crystal applied voltage in the preceding sub-frame period and newly writing the voltage, for obtaining gradation display. These are characteristics of the third embodiment.

In case of the third embodiment shown in FIG. 3, the second pixel memory 109 is in selected condition in the second sub-frame and the fourth sub-frame. In these sub-frames, the voltage 204 of the applied voltage wiring 103 is written to the liquid crystal 112. In the first and third sub-frames, the liquid crystal applied voltage 212 of the preceding sub-frame is maintained as they are.

At this time, in the first sub-frame, the liquid crystal applied voltage 212 is cleared by the liquid crystal applied voltage clear pulse at the end of the immediately preceding frame period. Accordingly, holding the preceding voltage is equivalent to holding of the clear condition.

Next, in the third embodiment, as shown in FIG. 6, the voltage 204 to be applied to the applied voltage wiring 104 becomes the voltage value V_{LC1} corresponding to the saturated luminance output in the first sub-frame. Therefore, per next sub-frame, the voltage values V_{LC2}, V_{LC3}, V_{LC4} become sequentially lowered in stepwise fashion.

Accordingly, in this case, since there is no liquid crystal applied voltage clear pulse between each sub-frames in one frame, the voltage shown as saturated luminance output is applied to the liquid crystal applied voltage throughout the frame period. As a result, as shown by broken line in FIG. 6, the pixel luminance 214 can be obtained. Irrespective of the response period of the liquid crystal to be used, saturated luminance can be output throughout one frame period.

As set forth, by the third embodiment, as multiple gradation level display method, since sub-frame luminance gradation modulation, in which the liquid crystal applied voltage of the preceding sub-frame is held, or the voltage is newly applied is selected, is employed. Even with TN type or IPS type liquid crystal, saturated luminance output or luminance output can be obtained throughout one frame period to significantly improve illumination efficiency to easily obtain bright display.

### Fourth Embodiment

Next, the fourth embodiment of the present invention will be discussed.

Here, in the foregoing embodiments, as the optical modulation element 111, the Tn type or IPS type liquid crystal 112 is employed. As shown in FIG. 7, the fourth embodiment employs an organic El element 115 as the optical modulation element 111. A current controlling active element 114 for controlling current to be supplied to the organic EL element 115, and a holding capacitor 113 connected to a gate terminal of the current controlling active element 114 for holding a voltage are employed. By this, a light emitting element as organic EL element is used as voltage control type optical modulation element similar to the liquid crystal.

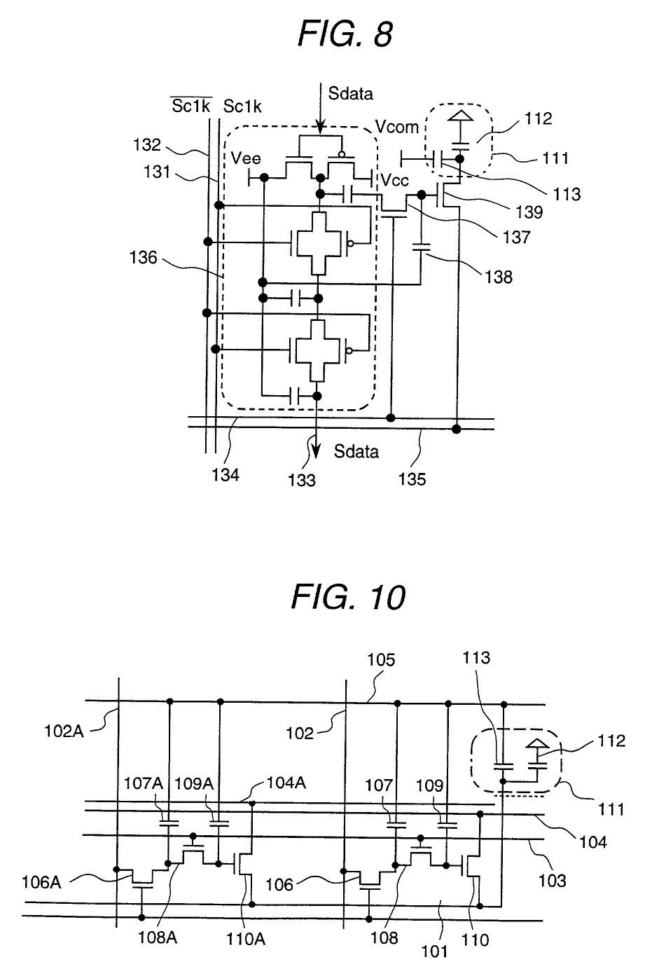

On the other hand, as the wiring for supplying current to the organic EL element 115, a current supply wiring 116 is provided. Other construction is the same as the first to third embodiments. Accordingly, the fourth embodiment corresponds to the construction where the optical modulation element 111 shown in FIG. 2 is replaced with the optical modulation element 111 in FIG. 8. Therefore, it can be used in the driving condition similar to the first to third embodiments.

Accordingly, for example, as multiple gradation level display method in the fourth embodiment, a method discussed in the third embodiment may be applied to operate in sub-frame luminance gradation modulation by selecting holding of the organic EL control voltage or newly applying the voltage. When the organic EL element is used as the optical modulation element, saturated luminance output can be obtained throughout one frame period to enable bright display.

### Fifth Embodiment

Next, discussion will be given for the fifth embodiment of the present invention.

In the fifth embodiment, as each pixel of the liquid crystal display portion 303 in FIG. 3, the circuit construction shown in FIG. 8 is employed. Other construction is the same as those in the first to third embodiments. Here, in case of the fifth embodiment, as shown in FIG. 8, in each pixel, one stage shift register 136 to be shifted by a shift clock 131 and inverted shift clock 132, is provided. The shift register 136 has a function for transferring a shift data 133 invertical direction according to a clock.

The shift data 133 held in the shift register 136 is transferred to the pixel memory 138 by situating the first active element 137 in conductive state by selecting the control signal wiring 134. The pixel memory 138 is connected to the gate terminal of the second active element 139.

Accordingly, the second active element 139 is controlled by a potential transferred to the pixel memory 138 and the voltage of the voltage wiring 135 is applied to the optical modulation element 111.

It should be noted that, in the fifth embodiment, the optical modulation element 111 is the liquid crystal the same as the first to third embodiments. However, the organic EL element may also be used similar to the fourth embodiment.

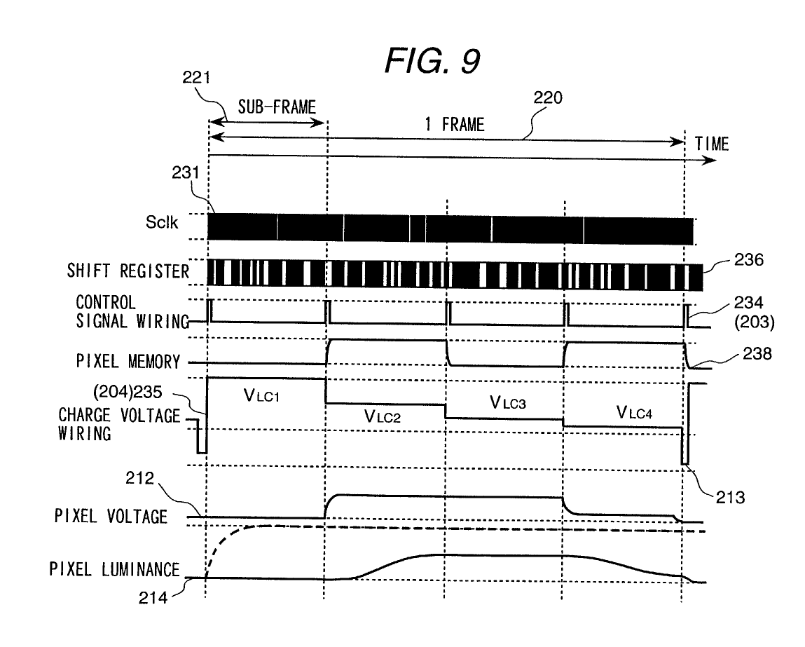

Next, driving state of the fifth embodiment of the display apparatus will be discussed with reference to FIG. 9.

The fifth embodiment is similar to the former embodiment in the point where one frame period 220 is divided into a plurality of sub-frames 221 in number corresponding to the gradation bit in each pixel component. In the shown embodiment, instead of mapping the display data by orthogonal matrix by the scanning wiring 101 and the data signal wiring 102, by a group of shift registers 136 formed by pixel group in vertical direction, using the shift register signal 236 synchronous with the shift rock 231 per sub-frame, display data is mapped per sub-frame.

Operation of FIG. 9 is similar to the former embodiment except that the voltage 202 to be applied to the data signal wiring 102 is replaced with the shift register signal 236 output from the shift register 136. Discussion for the operation similar to the former embodiments will be eliminated in order to avoid redundant discussion for maintaining the disclosure simple enough to facilitate clear understanding of the present invention. By this, the display data is mapped for the shift register 126 of the pixels in all display screens.

At this time, the display data signal for mapping is binary digital data expressing holding/writing. Furthermore, since the shift register 136 of each pixel drives the shift register 136 of the next pixel, the wiring delay can be small. As a result, high speed mapping can be done within quite short period.

Accordingly, by the fifth embodiment, even within the sub-frame divided into n, satisfactory data mapping can be performed easily. After mapping display data by the shift register 136, by applying the data transfer voltage 234 to the control signal wiring 134, the shift register signal 236 is transferred as the potential 238 of the pixel memory 138 and held in the next sub-frame period.

Then, conductive condition of the second active element 139 is controlled by the potential 238 of the pixel memory 138. As a result, it is determined whether the voltage 235 applied to the applied voltage wiring 135 is applied to the liquid crystal 112 or the voltage of the preceding sub-frame is held.

Here, an analog gradation value for the optical modulation element 111, namely writing period of the voltage value of the applied voltage wiring 135 is comparable with the sub-frame period. Therefore, the writing period is much longer period in comparison with the switching period of PWM.

On the other hand, writing of analog gradation value for the optical modulation element 111 and mapping of display data are separated, no blank period is present between the sub-frame displays to enable high speed rewriting of the image.

Accordingly, as set forth above, by the fifth embodiment, as mapping method of the display data, mapping method using the shift register included in each pixel, high speed mapping in comparison with the third embodiment becomes possible. Therefore, further increase of display frequency becomes possible.

### Sixth Embodiment

Next, the sixth embodiment of the present invention will be discussed with reference to FIG. 10.

Here, FIG. 10 is a circuit diagram showing a construction of the pixel structure ion the sixth embodiment. In this case, to the pixel circuit of the first embodiment, another set of a data signal wiring 102A and a first active element 106A, a first pixel memory 107, a first active element 108A, a second pixel memory 109A, a third active element 110A and an applied voltage wiring 104A are provided.

Accordingly, operation of the pixel shown in FIG. 10 is similar to that of the first embodiment as observed individually. Therefore, detailed discussion for operations of respective components will be eliminated to avoid redundant discussion for maintaining the disclosure simple enough to facilitate clear understanding of the present invention. In FIG. 10, input signal voltage (corresponding to the voltage 202 of FIG. 1) to be applied to two data signal wiring 101 and 102A, is configured to have three conditions of “non of the data signal wiring 102 and 102A is selected”, “only data signal wiring 102 is selected” and “only data signal wiring 102A is selected”.

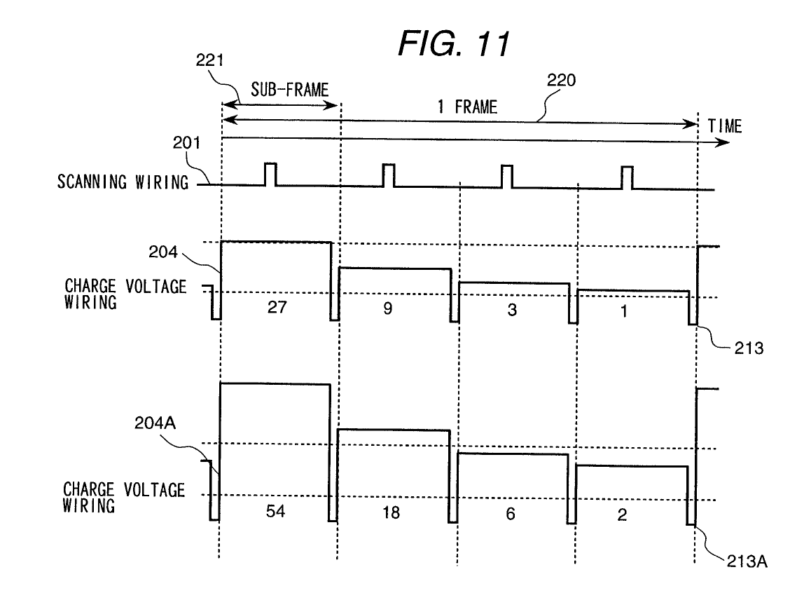

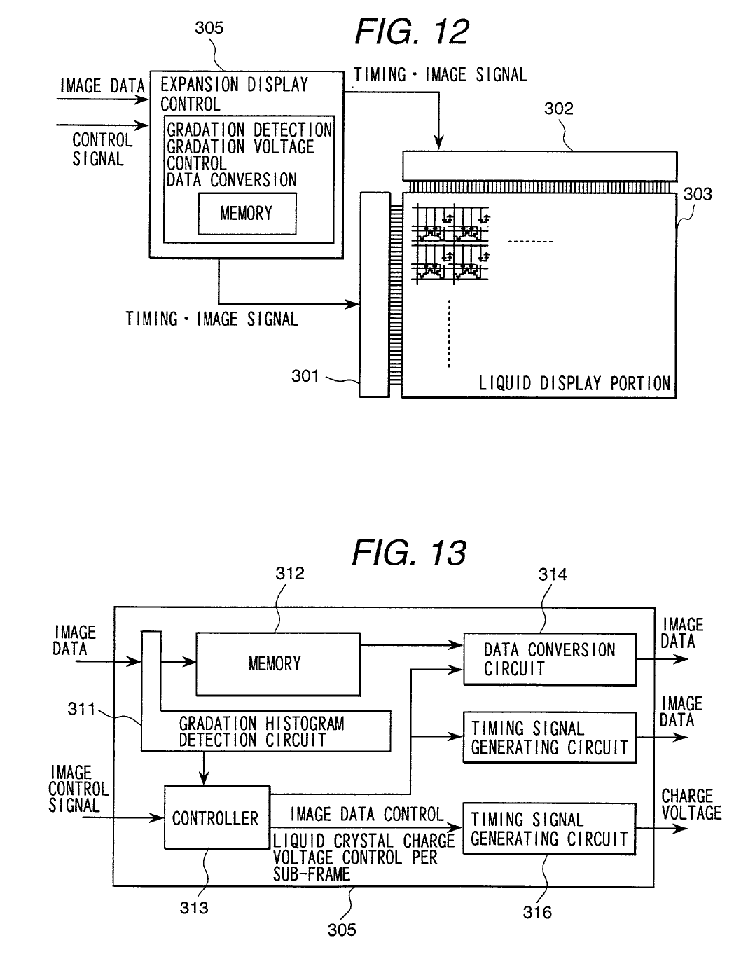

Next, operation of the sixth embodiment will be discussed with reference to FIG. 11.

FIG. 11 shows a driving condition of a par of the pixel. As can be clear from this, while the condition of the sub-frame in one frame period and timing of the voltage 201 supplied to the scanning wiring are similar to those in the first embodiment, voltages 204 and 204A to be applied to the applied voltage wiring 104 and 104A are different.

Namely, as shown, assuming the lowest voltage is 1, voltage 204 of n multiplied by 3 to the (m)th power, wherein m is integer, such as 3, 9, 27, . . . is applied in each sub-frame. In the applied voltage wiring 104A, the voltage value double of the voltage 204 is applied to the same frame.

Per each sub-frame, voltage for the data signal wiring 102 and the data signal wiring 102A is used selectively.

Then, in each sub-frame, the applied voltage wiring 104 and the applied voltage wiring 104A are selected and switched alternately or sequentially in each sub-frame. As a result, the voltage applied to the optical modulation element 111 is controlled at an eighty one kinds of values from 0 to 80.

Accordingly, by the sixth embodiment, with the construction and operation as set forth above, gradation display by ternary notation is obtained. As a result, while the first embodiment, in which binary gradation display control is affected, sixteen gradation level displays is obtained with four sub-frames, eighty-one gradation level displays can be obtained with four sub-frames.

Here, in the sixth embodiment, the applied voltage wiring 102 and 102A are employed. The applied voltage wiring can be three or more. In this case, display of further greater number of gradation levels can be obtained.

Furthermore, the driving method of the sixth embodiment may be combined with any driving method of the first to fifth embodiments.

### Seventh Embodiment

Next, discussion will be given for the seventh embodiment of the present invention.

Here, the third to fifth embodiment of the driving method, namely employing the sub-frame luminance gradation modulation selecting holding of the liquid crystal applied voltage of the preceding sub-frame or newly applying the voltage, accurate gradation control for the input image data is not always guaranteed,

The seventh embodiment is premised to the fourth embodiment. In the seventh embodiment, a gradation histogram of the image to be displayed is detected. Depending upon the result of detection of the gradation histogram, the voltage value 204 to be applied to the applied voltage wiring 104 in each sub-frame period is adjusted to obtain accurate gradation control for the input image.

Namely, in the seventh embodiment, for example, in the gradation histogram of the image to be displayed, for example, upon displaying a whitish image having a peak at high portion of the gradation bit number, for displaying high gradation portion in detail, the voltage is adjusted per sub-frame for application of the voltage near voltage value shown in high gradation level precisely.

When the liquid crystal for black display upon absence of application of voltage is used as optical modulation element, as particular voltage adjusting method in the seventh embodiment, as shown in FIG. 9, assuming that the voltage value V_{LC1} is a voltage value corresponding to saturated luminance output for white display, other voltage values V_{LC2}, V_{LC3}, V_{LC4} are adjusted to be shifted to higher voltage values, respectively.

Then, in the seventh embodiment, the gradation information of the image top be displayed is detected to adjust the applied voltage and so forth are adjusted according to the result of detection. In place of the display controller shown in FIG. 3, an expanded display controller 305 incorporating functions of gradation detection, gradation voltage control, data conversion and so forth is employed.

FIG. 13 is a block diagram of the extended display controller 305. Here, at first, the image data is input to a gradation histogram detection circuit 311. Here, after sequential detection of gradation information, the detected gradation information is stored in the memory 312.

It should be noted that the construction of FIG. 13 is the same as the construction of FIG. 3 expect for the extended display controller 305. Discussion other than the extended display controller 305 will be eliminated in order to avoid redundant discussion for maintaining the disclosure simple enough to facilitate clear understanding of the present invention.

After detection of gradation information of the image data for one screen image, the gradation histogram detection circuit 311 aggregate those information to output a controller 313 as gradation histogram for one display screen.

The controller 313 determines the applied voltage per each sub-frame on the basis of the gradation histogram for one screen image for outputting the voltage set per sub-frame by controlling the liquid crystal applied voltage generation circuit 316.

On the other hand, the controller 313 controls the data conversion circuit 314. The image data stored in the memory 312 is output by converting the image data corresponding to the applied voltage per sub-frame. Simultaneously, the timing signal generation circuit 315 is controlled to output the control signal.

Here, in the seventh embodiment, the gradation histogram per each color of RGB of the image data to control the voltage to be applied to each sub-frame. However, it is possible to detect gradation histogram aggregating respective colors of RGB and to apply the same voltage to all of pixel components per sub-frame.

With the construction set forth above, by the seventh embodiment, for multiple level gradation display, for using sub-frame luminance gradation modulation to hold the liquid crystal applied voltage in the preceding sub-frame and newly apply the voltage, the gradation information of the image to be displayed is detected to control the input value of the luminance gradation in each sub-frame on the basis of the result of detection. Therefore, more high precision luminance gradation modulation system can be realized to obtain the display apparatus of higher performance.

### Eighth embodiment

In the seventh embodiment, when the applied voltage in each sub-frame is controlled by detecting gradation information of the image to be displayed, by narrowing the luminance gradation level range which can be modulated in one frame period, the luminance gradation modulation can be provided higher precision beyond number of gradation levels of the input image data.

However, in this case, it is wasteful to increase precision of the gradation precision beyond the image information to be contained in the input image data.

For example, in case of the display apparatus of 1024×768 pixels in 24 bit (8 bit in each color) of gradation display per pixel, about sixteen million kinds of colors can be displayed. However, number of pixels is about eight hundreds thousands. Therefore, even when different colors are displayed in all pixels, only one twentieth can be used as gradation range.

Accordingly, number of sub-frames as a factor for increasing number of gradation levels may be reduced to have the gradation precision about original image.

In practice, number of colors displayed in one display screen is further smaller and further correlated. Therefore, the gradation range to be expressed is further limited. In this case, even when number of sub-frames may be eight, for example, or even six or seven or lesser.

On the other hand, in the seventh embodiment, the gradation information is detected from the image to be displayed. It is possible to have satisfactory display even at smaller bit number than original gradation bit number. For example, it is the case when image data of black and white of two values (=1 bit) for displaying character information is input for the display apparatus which can display image input of four bits per color.

In such case, it is wasteful to keep number of sub-frames to be four as in the seventh embodiment. In such case, number of sub-frame can be set to one.

Therefore, the eighth embodiment detects gradation histogram by the gradation histogram detecting circuit 311 of the extended display controller 305 and controls controller 313 on the basis of result of detection. By determining number of sub-frames per one frame on the basis of the result of detection, the voltage to be applied in each sub-frame is determined.

Here, even in the eighth embodiment, except for the extended display controller 305, other construction and operation are the same as those in the seventh embodiment. Therefore, discussion for the component other than extended display controller 305 will be eliminated in order to avoid redundant discussion for maintaining the disclosure simple enough to facilitate clear understanding of the present invention.

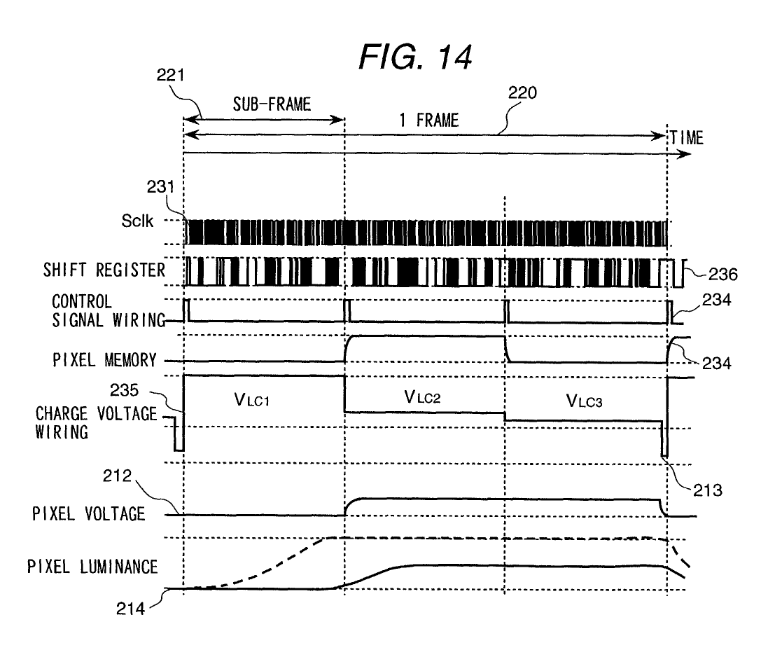

Next, driving condition of the pixel in the eighth embodiment will be discussed with reference to FIG. 14. In FIG. 14, normally, shows the case where a display mode with four sub-frames as shown in FIG. 9, is switched into display mode with three sub-frames at certain timing. In case of the display mode with three sub-frames, as the pixel voltage 212, the voltage V_{CL2} is applied as shown, and is held during the third sub-frame period.

With the eighth embodiment, number of sub-frames is controlled depending upon the image data. Therefore, an average number of sub-frames per one frame can be reduced. As a result, it is further facilitated to adapt for further increase of the display frequency.

In short, in the eighth embodiment, as the multiple level display method, the sub-frame luminance gradation modulation selecting holding the voltage in the preceding frame and applying of new voltage, and the gradation information of the image to be displayed is detected for controlling number of sub-frames in one frame and the input value of the luminance gradation in each sub-frame depending on the result of detection. Thus, it becomes possible to adapt to higher display frequency.

### Ninth Embodiment

Next, discussion will be given for the ninth embodiment of the present invention.

Here, the driving method in the eighth embodiment is the method for reducing number of sub-frames when the display gradation number is small. The ninth embodiment is premised to the eighth embodiment and permits external control of number of sub-frames by the display gradation number control signal supplied externally. Thus, number of sub-frames can be reduced as required.

Therefore, in the ninth embodiment, as shown in FIG. 15, the display gradation number control signal 317 is input to the extended display controller 305. Accordingly, other construction and operation is the same as the eighth embodiment. The display gradation number control signal 317 can be a signal for varying number of gradation levels to be number of gradation level of the input original image to number of gradation levels of the image to be displayed.

Accordingly, in the ninth embodiment, by externally controlling the display gradation number control signal 317, number of gradation levels of the image to be displayed can be made smaller than number of gradation levels of the input original image. As a result, number of sub-frames and display frequency in one frame period can be reduced.

For example, the display gradation number control signal 317 may be controlled to permit the user of the display to input or not. As a result, even when number of display gradation in battery operation, it can be easily adapted even for power saving.

By the system for controlling the display apparatus, when the display apparatus is not used for a given period, the display gradation number control signal 317 is supplied to the extended display controller 305 for suppressing power consumption to achieve power saving.

As set forth above, in the ninth embodiment, for multiple level gradation display, for using sub-frame luminance gradation modulation to hold the liquid crystal applied voltage in the preceding sub-frame and newly apply the voltage, the gradation information of the image to be displayed is detected to control the input value of the luminance gradation in each sub-frame on the basis of the result of detection. Therefore, more high precision luminance gradation modulation system can be realized to obtain the display apparatus of higher performance.

Furthermore, in the ninth embodiment, by adjusting the display gradation number control signal 317, display gradation number is reduced and whereby number of sub-frames can be reduced without varying length of one frame period, one sub-frame period can be made longer to lower display frequency.

### Tenth Embodiment

Discussion will be given for the tenth embodiment of the present invention.

In case of the ninth embodiment, by adjusting the display gradation number control signal 317, one sub-frame can be made longer to permit lowering display frequency. In contrast to this, in the tenth embodiment, when number of sub-frames is reduced by reducing display gradation number, the sub-frame period can be shortened depending thereon.

By this, the frame period is shortened. As a result, by the tenth embodiment, image rewriting frequency (refresh rate) can be made higher.

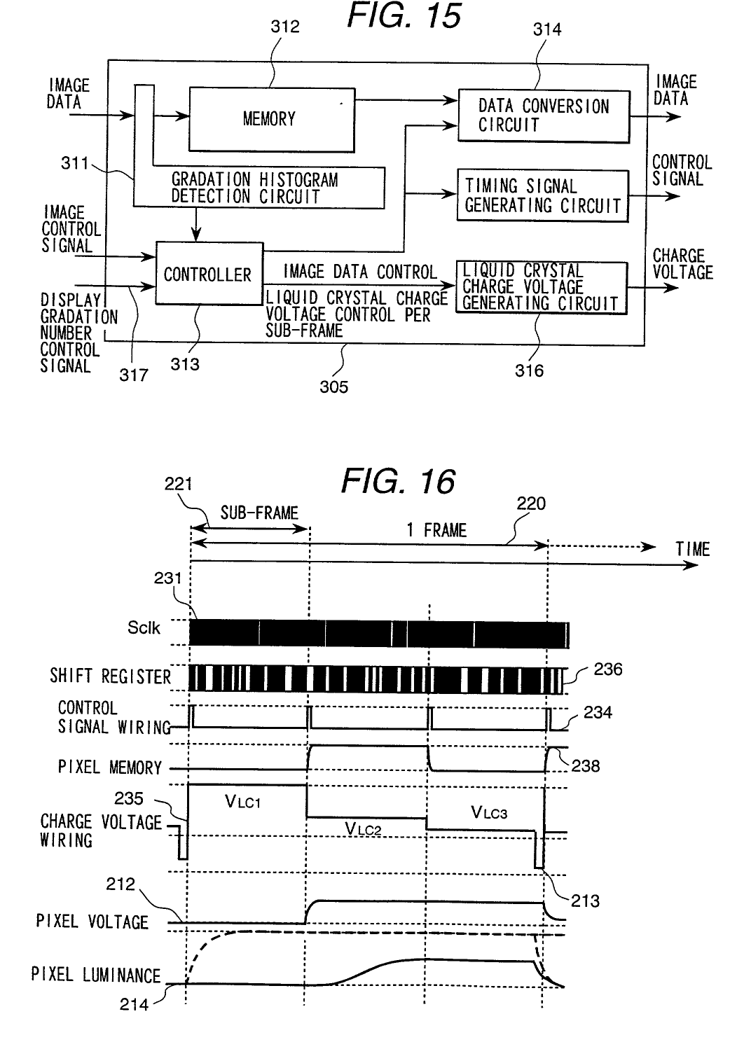

Driving condition of the pixel is shown in FIG. 16.

In the tenth embodiment, FIG. 16 shows one embodiment of the case where the image display which has been a display mode with four sub-frames, is controlled to switch into the display mode with three sub-frames. In this case, one sub-frame period is unchanged when the display mode is varied. The frame period is made shorter.

As set forth above, in the tenth embodiment, for multiple level gradation display, for using sub-frame luminance gradation modulation to hold the liquid crystal applied voltage in the preceding sub-frame and newly apply the voltage, the gradation information of the image to be displayed is detected to control the input value of the luminance gradation in each sub-frame on the basis of the result of detection. Therefore, more high precision luminance gradation modulation system can be realized to obtain the display apparatus of higher performance.

### Eleventh Embodiment

Next, discussion will be given for the eleventh embodiment of the present invention will be discussed,

In the ninth and tenth embodiment, when number of display gradation is reduced by the display gradation number control signal 317, the display image quality is naturally lowered.

Therefore, in the eleventh embodiment, when the same gradation level is displayed over a plurality of frames, the controller 313 in the extended display controller 305 is provided a function for adjusting number of gradation levels of the image to be displayed over a several frames by adjusting the input value for the luminance gradation to be newly applied in each sub-frame.

BY this function, when number of display gradation levels is reduced by the display gradation number control signal 317, lowering of the display image quality can be accommodated. Accordingly, by the eleventh embodiment, it becomes possible to easily provide the high performance display apparatus by applying the image display of high definition.

With the present invention, the TN type or the IPS type liquid crystal, even when the optical modulation element having relatively low response speed, the sufficiently high display frequency can be attained to easily obtain bright and high performance display apparatus at low cost.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A display apparatus of a system for separately performing mapping of display data for optical modulation element of each pixel and application of gradation information, comprising:
a display period of one frame being divided into a plurality of sub-frames;
input value for said optical modulation element being controlled independently per each sub-frame in said plurality of sub-frames; and
image being displayed with gradation display by said optical modulation element.

2. A display apparatus as set forth in claim 1, wherein said optical modulation element is constructed with a liquid crystal having response speed longer than or equal to 5 msec.

3. A display apparatus as set forth in claim 1, wherein
said mapping of the display data for said optical modulation element is performed with a construction of a substantially orthogonal two signal wiring and a first active element arranged at the intersection of said two signal wiring for performing mapping of the display data in a first memory of each pixel, and
application of gradation information for said optical modulation element is performed by transferring the display data mapped in said first memory to a second memory in each pixel by a second active element in each pixel, and an input value is transferred to said optical modulation element by a third active element in each pixel.

4. A display apparatus as set forth in claim 1, wherein said mapping of the display data for said optical modulation element is performed by mapping of the display data in a first memory in each pixel using a shift register incorporated per one stage in said pixel, and
application of gradation information for said optical modulation element is applied by transferring the an input value to said optical modulation element according to the display data transferred to said first memory.

5. A display apparatus as set forth in claim 1, wherein
a first gradation information is applied simultaneously with mapping of the image data for said pixel,
a second gradation information is applied for said pixels independently of mapping, and
luminance gradation modulation is performed per sub-frame simultaneously using said first gradation information and said second gradation information for obtaining gradation display.

6. A display apparatus as set forth in any one of claims 1 to 5, wherein
when an image having number of gradation levels of substantially 2ⁿ is to be displayed, one frame period as a period for displaying one frame of screen image is divided into n in number of equal period sub-frames,
in each sub-frame, each pixel is selected into display condition and non-display condition according to a preliminarily mapped display data, and
an input value for luminance gradation of the pixel to display in each sub-frame is mutually differentiated.

7. A display apparatus as set forth in claim 6, wherein the input value for the luminance gradation of the pixel to be displayed in each sub-frame is any one of 1B, 2B, 2²B, . . . 2ⁿB with taking the input value for the lowest luminance gradation is 1B.

8. A display apparatus as set forth in claim 6, wherein total value or effective value of all sub-frame of the input values for luminance gradation of the pixel to be displayed in each sub-frame is substantially equal to the input value required for saturated luminance output of said optical modulation element.

9. A display apparatus as set forth in claim 1, wherein the pixel in certain frame or certain sub-frame is displayed using information of pixel in preceding frame or preceding sub-frame in time.

10. A display apparatus as set forth in any one of claims 1 to 5, wherein
when an image having number of gradation levels of substantially 2ⁿ is to be displayed, one frame period as a period for displaying one frame of screen image is divided into less than or equal to n in number of equal period sub-frames, each pixel in each sub-frame is selectively held at the input value for luminance gradation of preceding frame according to the preliminarily mapped display data or newly applied the input value,
the input values for luminance gradation to be newly applied in each sub-frame are mutually differentiated.

11. A display apparatus as set forth in claim 10, wherein the input value for the luminance gradation to be newly applied in each sub-frame is adjusted according to detection of gradation information of the image to be displayed.

12. A display apparatus as set forth in claim 11, wherein when an image having number of gradation levels of substantially 2ⁿ is to be displayed, one frame period as a period for displaying one frame of screen image is divided into less than n in number of equal period sub-frames.

13. A display apparatus as set forth in claim 11, wherein number of gradation levels of display image is detected and number of sub-frames in one frame period is adjusted depending upon result of detection of number of gradation levels.

14. A display apparatus as set forth in claim 11, wherein number of sub-frames in one frame period is adjusted by varying number of gradation levels of the display image for adjusting a driving frequency.

15. A display apparatus as set forth in claim 11, wherein number of sub-frames in one frame period is adjusted by varying number of gradation levels of the display image for adjusting one frame period.

16. A display apparatus as set forth in claim 10, wherein number of gradation levels of the image to be displayed over a several frame period is adjusted by adjusting input value for luminance gradation to be newly applied in each sub-frame, per frame.
